(19) United States
(12) Patent Application Publication
(10) Pub. No.: US 2016/0360206 A1
(43) Pub. Date: Dec. 8, 2016

(54) RATE CONTROLLER FOR REAL-TIME ENCODING AND TRANSMISSION

(71) Applicant: Microsoft Technology Licensing, LLC, Redmond, WA (US)

(72) Inventors: Yongjun Wu, Bellevue, WA (US); Weidong Zhao, Bellevue, WA (US); Shyam Sadhwani, Bellevue, WA (US)

(21) Appl. No.: 14/731,306

(22) Filed: Jun. 4, 2015

(51) Int. Cl. H04N 19/146; H04N 19/142; H04N 19/895; H04N 19/593; H04N 19/87; H04N 19/115; H04N 19/179

(52) U.S. Cl. CPC H04N 19/146; H04N 19/115; H04N 19/142; H04N 19/179; H04N 19/593; H04N 19/87; H04N 19/895

(57) ABSTRACT

In response to a scene change being detected in screen content, a rate controller instructs a video encoder to generate an intraframe compressed image. The rate controller computes a target size for compressed image data using a function based on a maximum compressed size for a single image, i.e., without buffers for additional image data. For a number of images processed after detection of the scene change, this target size is computed and used to control the video encoder. After this number of images is processed, the rate controller can resume to a prior mode of operation. Such rate control reduces latency in encoding and transmission of screen content, which improves user perception of responsiveness of a host computer, such as for interactive video applications.

### BACKGROUND

In some computing applications, a remote client computer accesses a host computer that provides screen content for display on the remote client computer. For example, the host computer can be connected to a remote display. As another example, the host computer and remote client computer can support an interactive video application. As another example, the host computer can support a remote desktop application. The screen content is data that is generally in the form of an image. The host computer periodically generates the screen content and transmits it to the remote client computer for display.

In such applications, the host computer generates the screen content and transfers the screen content to the remote client computer in an interactive user session in which changes to the screen content on the host are intended to be reflected at roughly the same time on the remote client computer. To improve transmission time, and to reduce latency and bandwidth utilization, the host computer encodes the screen content to produce an encoded bitstream, and the encoded bitstream is transmitted to the client computer.

An encoded bitstream typically conforms to an established standard. An example of such a standard is a format called ISO/IEC 14496-10 (MPEG-4 Part 10), also called ITU-T H.264, or simply Advanced Video Coding (AVC) or H.264. Herein, a bitstream that is encoded in accordance with this standard is called an AVC-compliant bitstream.

Many such standards, particularly those used for transmitting video data, include a form of data compression called motion compensation. Motion compensation is one type of compression technique, called “interframe” encoding, which reduces interframe redundancies in a sequence of images. A compression technique that reduces redundancies of information within an image is called “intraframe” encoding. Generally speaking, interframe redundancies in a sequence of images are reduced by defining groups of images in the sequence, with each group having one or more reference images to which the remaining images in the group are compared. Comparison results are computed and encoded to reduce the amount of information stored to encode the group of images.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

When there is a significant change in the screen content generated by the host computer, the bit rate of the encoded bitstream can suddenly increase. Such an increase in bit rate, if not managed properly, can increase latency between the time the host computer generates screen content and the time the remote client computer displays that screen content. In particular, conventional video encoders tend to introduce latency, when encoding video in response to significant changes in image content, due to buffering used to maintain video quality and smooth data flow. Such increased latency can result in a user perception of delayed response time of the host computer and/or can result in a visual glitch.

In response to a change in screen content, the host computer manages encoding of the screen content so as to reduce delay in generating and transmitting an encoded bitstream. More particularly, the host computer includes a rate control which configures the host computer to control the bit rate of the encoded screen content as generated by a video encoder so as to minimize latency in generating and transmitting the encoded bitstream.

Thus, a host computer can include a video encoder and a rate controller configured to control the video encoder. The video encoder includes an input configured to receive a target size of compressed image data for a next image to be encoded. A first output is configured to output an encoded image according to the received target size. A second output is configured to output an actual size of the encoded image. The rate controller includes a first input configured to receive an indication of a scene change, a second input coupled to the second output of the video encoder and configured to receive the actual size of the encoded image. An output is configured to output a target size for the next image to be encoded. The rate controller is configured to have a first mode of operation and a second mode of operation, and to transition to the second mode of operation based at least on the indication of the scene change.

In one embodiment, in response to a scene change being detected in screen content, a rate controller instructs a video encoder to generate an intraframe compressed image. The rate controller computes a target size for compressed image data using a function based on a maximum compressed size for a single image, i.e., without buffers for additional image data. For a number of images processed after detection of the scene change, this target size is computed and used to control the video encoder. After this number of images is processed, the rate controller can resume a prior mode of operation.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example operating environment of a host computer transmitting encoded image data to a remote client computer.

FIG. 2 is a block diagram illustrating a relationship between rate controller and a video encoder.

FIG. 3 is a flow chart describing an example implementation of a rate controller switching between two modes in response to detecting a scene change.

FIG. 4 is a flow chart describing an example implementation of zero-buffering mode of a rate controller.

FIG. 5 is a block diagram of an example computing device with which components of such a system can be implemented.

### DETAILED DESCRIPTION

The following section provides an example operating environment of a host computer transmitting encoded image data to a remote client computer.

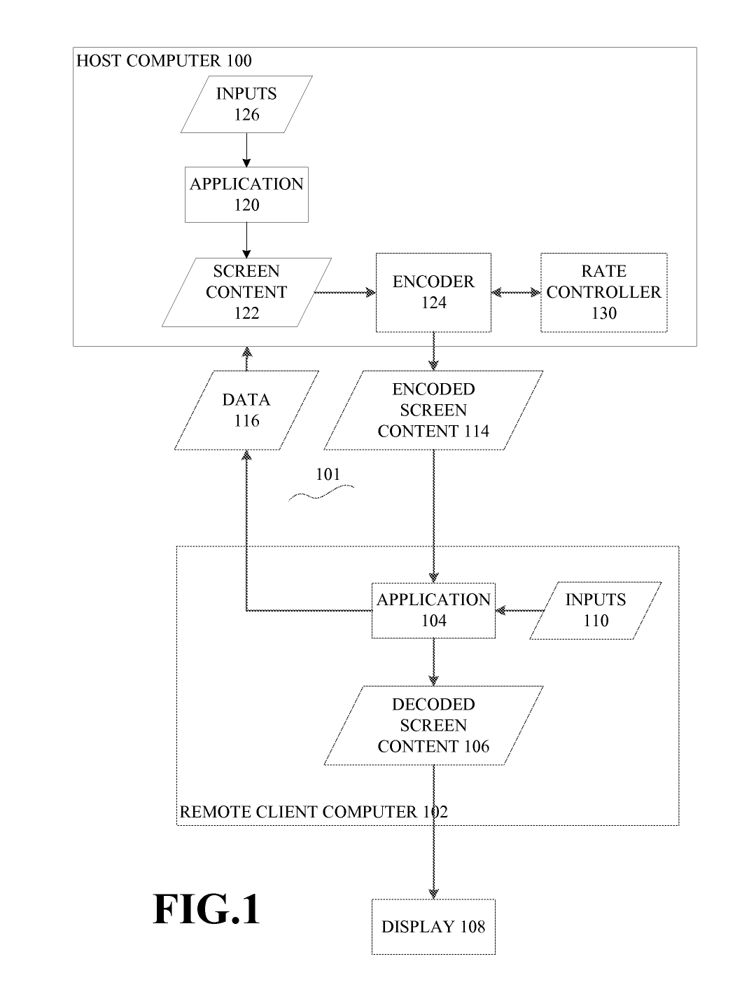

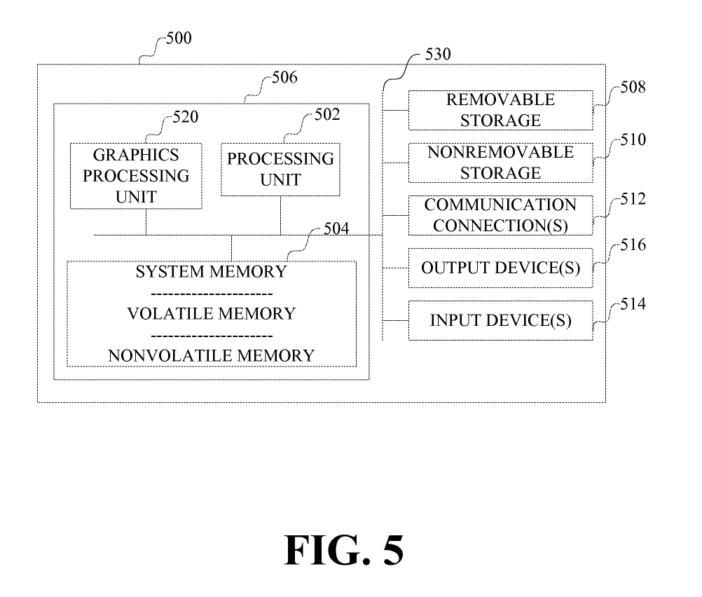

Referring to FIG. 1, this example operating environment includes a host computer 100. A host computer can be implemented using a computer such as described below in connection with FIG. 5 and configured with sufficient processors, memory and storage to support hosting an operating system and applications. The host computer 100 includes one or more applications 120, examples of which are described in more detail below, through which the host computer periodically generates screen content 122. The screen content 122 can change in response to, among other things, inputs 126 to the application 120. Such inputs can include, for example, inputs through a user interface device or image data from a camera. The host computer can receive such inputs from one or more input devices (not shown) connected to the host computer, or can generate those inputs. The host computer can output the screen content 122 to a display device (not shown) connected to the host computer.

The host computer includes a video encoder 124, examples of which are described in more detail below, which has an input configured to receive the screen content 122 and an output configured to provide encoded screen content 114.

In this example operating environment, the host computer 100 is connected to a remote client computer 102 over a communication connection 101. The communication connection can include any communication connection between two computers over which the host computer can transmit encoded screen content to the remote client computer, including but not limited to a wired or wireless computer network connection, or a radio connection. The host computer 100 periodically transmits the encoded screen content 114 over the communication connection 101 to the remote client computer.

The remote client computer 102 can be implemented using a computer such as described below in connection with FIG. 5 and configured with sufficient processors, memory and storage to support hosting an operating system and applications. The remote client computer 102 includes an application 104 that configures the remote client computer to output decoded screen content 106 to a display 108. The remote client computer receives encoded screen content 114 from the host computer 100 over the communication connection 101. The application 104 configures the remote client computer 102 to decode the encoded screen content 114 to generate the decoded screen content 106. In such applications, changes to screen content at the host are intended to be reflected on the display 108 at the remote client computer at roughly the same time the changes are made at the host. Such timing is roughly the same if the display on the remote client computer gives the impression to a user of the remote client computer that the host computer is responsive.

Generally, the remote client computer can be any computer that is configured to receive, decode and display the encoded screen content 114 from the host computer 100 over the communication connection 101. Such a remote client computer includes a video decoder (not shown) capable of decoding encoded data from the host computer.

Given the example operating environment of FIG. 1, such a computer system can be utilized for several purposes.

As an example implementation, the host computer can be configured as a personal computer, tablet computer, mobile phone or other mobile computing device to support hosting an operating system and applications. The remote client computer can be configured as a display device with a built-in computer, such as a smart television or smart projection system, which executes a remote display application. In such an implementation, for example, a user of a mobile phone, as a host computer, can connect the mobile phone to an external display, as a remote client computer. The application 120 in this instance can be the operating system providing access to a remote display.

As an example implementation, the host computer can be configured as a personal computer, tablet computer, mobile phone or other mobile computing device to support hosting an operating system and applications. The remote client computer can be configured with an application that provides a remote desktop configured to access the host computer. The remote client computer can be configured, for example, as a personal computer, mobile computing device, tablet computer, or mobile phone. In such an implementation, for example, a user of a personal computer, as a host computer, can connect the personal computer to a computer network and configure the personal computer to respond to access requests from remote client computers in which the remote client computer can view screen content generated by the host computer. In this example, the application 120 can be a remote access application on the host computer.

As another example implementation, the host computer can be configured, for example, as a server computer to support hosting operating systems and applications for remote desktops for multiple users. For simplicity of illustration, a host computer providing screen content for a single desktop will be described herein. The remote client computer can be configured with an application that provides a remote desktop configured to access the host computer. The remote client computer can be configured, for example, as a personal computer, mobile computing device, tablet computer, or mobile phone. In this example, the application 120 can be a remote access application on the host computer.

As another example implementation, the host computer can be configured as a personal computer, tablet computer, mobile phone or other mobile computing device that supports hosting an operating system and applications. The remote client computer can be configured, for example, as a personal computer, mobile computing device, tablet computer, or mobile phone. Both the host computer can be provided with an application 120 that implements an interactive video application where video from one device is set as screen content to be displayed on the other device.

In one implementation for remote desktops, the application 104 also can configure the remote client computer 102 to process inputs 110 from input devices (not shown), to support a remote desktop. The remote client computer 102 can send data 116 representing the inputs 110 to the host computer 100 over the communication connection 101. The host computer 100 processes the data 116 and transforms the data into inputs 126 to an application 120, which can result in a change to the screen content at the host computer.

In such applications, when there is a significant change in the screen content 122 generated by the host computer, the bit rate of the encoded bitstream can suddenly increase. Such an increase in bit rate can increase latency between the time the host computer generates screen content and the time the remote client computer displays that screen content. Such increased latency can result in a user perception of delayed response time of the host computer. In response to a change in screen content, the host computer manages encoding of the screen content so as to reduce delay in generating and transmitting an encoded bitstream. More particularly, in the implementation shown in FIG. 1, the host computer 100 includes a rate controller 130 which configures the host computer to control the bit rate of the encoded screen content as generated by the video encoder 124 so as to minimize latency in generating and transmitting the encoded bitstream.

In particular, in response to a significant change in the screen content, the rate controller 130 causes the video encoder to transition from a first mode of operation and enter into a second mode of operation, which can use zero buffering.

In the first mode of operation, the video encoder uses a non-zero amount of buffering such that, if an encoded image exceeds its target size, then the video encoder uses available buffering to adapt to an increased bit rate, while slowly adapting encoding parameters to match the target size over time. The maximum size of an encoded image in this first mode generally can be specified using a function of the number of buffers available, the number of buffers already used, and the target bit rate and available bandwidth for transmission.

In response to the significant change in the screen content, the video encoder enters a second mode of operation in which the target size of an encoded bitstream for an image is limited to an amount of data that can be transmitted to the remote client computer in one period of a temporal sampling rate of the screen content as displayed at the remote client computer. If the actual size of the encoded bitstream for an image exceeds this target size by a threshold amount, then the image, or a next image, can be dropped. The rate controller can enter this second mode for a predetermined number of input images, after which time the rate controller can transition back to its first mode of operation. The maximum size of an encoded bitstream for an image in the second mode generally is a function of the duration of display of one frame of screen content and a target bit rate for transmission of one frame. Such a result can be achieved by setting a number of available buffers to zero, to provide a zero-buffering mode.

By using such a zero-buffering mode of operation, latency in transmitting the encoded bitstream for the next image after the scene change is optimized, but given precedence over image quality, so as to ensure the display on the remote client computer remains responsive to changes in screen content.

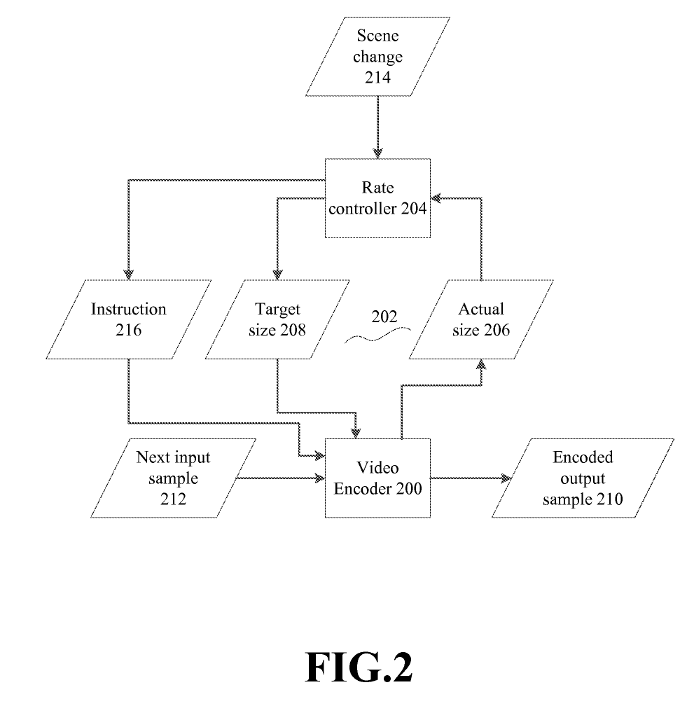

A more detailed description of an example implementation of such a rate controller 130 and video encoder 124 on a host computer will now be described in more detail in connection with FIGS. 2 through 4.

As shown in FIG. 2, a video encoder 200 is configured to include an interface 202 through which the video encoder can provide information and receive information to effect rate control by a rate controller 204. This interface includes an output 206 configured to provide an indication of an actual size of the last encoded output sample 210 generated by the video encoder 200 in response to the last input sample 212. The interface also includes an input 208 configured to receive an indication of a target size for the next encoded output sample 210 generated for a next input sample 212 in encoding order. The size should be understood as an amount of data, which can be represented, for example, as a number of bytes or bits or as an amount time for transmission of the data. The interface can include additional commands and data to permit the rate controller or other application to interact with the video encoder. For example, the rate controller 204 can provide an instruction 216 to the video encoder specifying a type of encoding to perform on an image, such as directing the video encoder to encode an image using intraframe encoding. The target size, for example, can be processed by the video encoder to generate encoding parameters such as quantization parameters. Alternatively, the encoding parameters, such as quantization parameters, for the video encoder may be separately set.

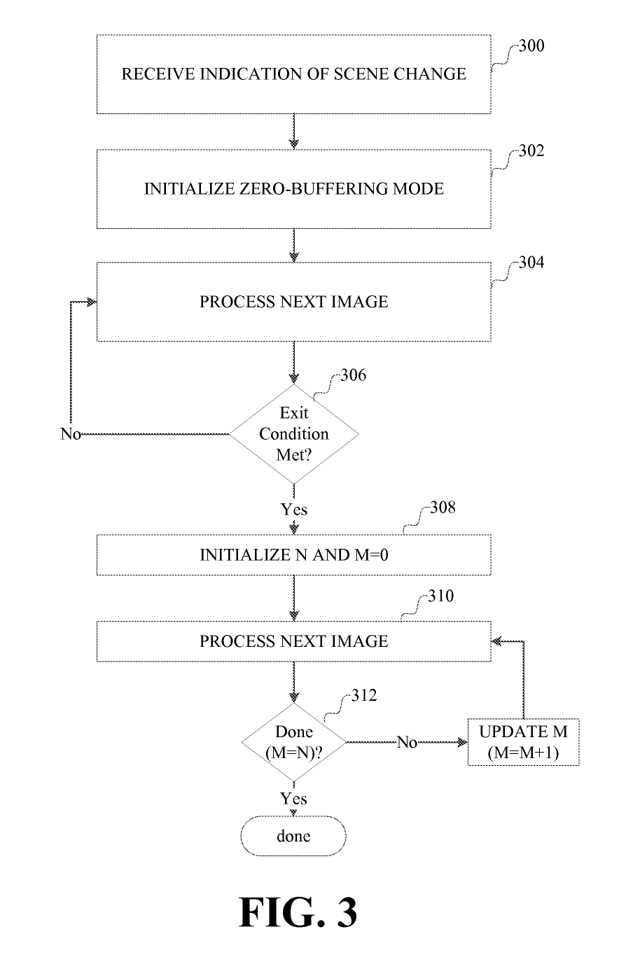

In FIG. 2, the rate controller 204 receives the actual size 206 of the last output sample 210 and provides the target size 208 for the encoded output sample for the next input sample. The rate controller 204 can compute the target size, as described in more detail below in connection with FIG. 3, based on the actual size 206 of the last output sample and a number of other factors, such as available buffering, desired transmission bit rate, and whether a change in the screen content has been detected, as indicated at 212.

The video encoder 200 can be implemented in a number of ways. In some implementations, the video encoder can be implemented using a computer program that is executed using a central processing unit (CPU) of the host computer. In such an implementation, the video encoder accesses image data from memory accessible to the video encoder through the CPU.

In some implementations, the video encoder can be implemented using a computer program that is utilizes resources of a graphics processing unit (GPU) of the host computer. In such an implementation, a part of the computer program implementing the video encoder can be executed on a central processing unit (CPU) of the host computer, which in turn manages execution of another part of the computer program on the GPU by providing image data and encoding parameters to the GPU. In some implementations, the part of the video encoder implemented on the GPU can be implemented using a computer program that is called a “shader”. In some implementations, the portion of the video encoder implemented on the GPU can include custom firmware of the GPU. In yet other implementations, the portion of the video encoder implemented on the GPU can include functional logic of the GPU dedicated to video encoding operations.

In some implementations, the video encoder can be implemented in part using functional logic dedicated to video encoding operations. Such a video encoder generally includes processing logic and memory, with inputs and outputs of the video encoder generally being implemented using one or more buffer memories. The processing logic can be implemented using a number of types of logic device or combination of logic devices, including but not limited to, programmable digital signal processing circuits, programmable gate arrays, including but not limited to field-programmable gate arrays (FPGA's), application-specific integrated circuits (ASICs), application-specific standard products (ASSPs), systems-on-a-chip systems (SOCs), complex programmable logic devices (CPLDs), or a dedicated, programmed microprocessor. Such a video encoder can be implemented as a coprocessor within the host computer. In such an implementation, a computer program executed on the processing unit (CPU) can manage utilization of the video encoder and also influence rate control by communicating with the video encoder through an application programming interface.

In some implementations, the video encoder can utilize and application programming interface (API) to access a graphics library, where a video encoder is implemented within the graphics library. The video encoder within the graphics library may execute on a CPU only or may use GPU resources as well, or may use functional logic in the host computer that is dedicated to video encoding operations.

The rate controller 204 also can be implemented in a number of ways. In one implementation, the rate controller can be implemented using a computer program that is executed using a central processing unit (CPU) of the host computer. In such an implementation, the rate controller accesses image data from memory accessible to the rate controller through the CPU. In some implementations, the rate controller also can be implemented using a coprocessor in the host computer or other dedicated functional logic.

Regarding the interface between the rate controller and video encoder, in one implementation, the rate controller and video encoder can be implemented using separate process threads through which data can be shared by communication through conventions provided by the operating system of the host computer. In another implementation, the video encoder generates events in an operating system of the host computer, and the rate controller is configured to receive such events. An interrupt-based system also can be provided. If the rate controller and video encoder are implemented in hardware, such an interface can be provided by registers or other memory devices accessible to both devices.

Referring now to FIG. 3, a flowchart of an example operation of the host computer will now be described.

The zero-buffering mode is entered in response to the rate controller receiving (300) an indication of a scene change being detected in the screen content. The zero-buffering mode is initialized (302) by the rate controller setting the values of several variables used in the rate control process, examples of which are described below. The rate controller processes (304) data for the next image, including receiving data about the actual size of the compressed image from the video encoder and computing and providing a target size to the video encoder. If an exit condition for exiting the zero-buffering mode has not yet been reached, as indicated at 306, the next image is processed as indicated at 304. Otherwise, if the exit condition has been reached, the rate controller initializes (308) a number N of frames for which the zero-buffering mode is to run and a related count (e.g., N=a positive integer and M=1). The rate controller processes the next image 310, including receiving data about the actual size of the compressed image from the video encoder and computing and providing a target size to the video encoder. In the number N of frames has been reached (e.g., M=N), as determined at 312, processing in the zero-buffering mode can stop; otherwise a count of the number of frames processed is updated (e.g., M=M+1), as indicated at 314, and the next image is processed (310).

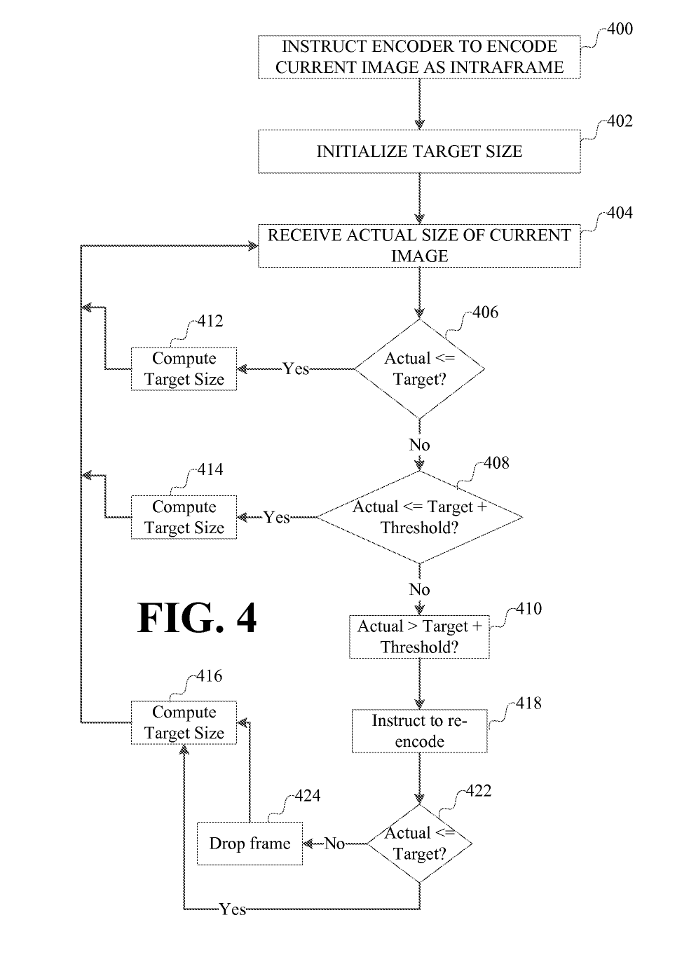

Turning now to FIG. 4, the zero-buffering mode involves instructing (400) the video encoder to encode the current image an intraframe compressed image. Depending on the encoding standard implemented by the video encoder, additional information can be encoded with the intraframe compressed image. In one implementation, using the H.264 standard, this image can be encoded as an “IDR” frame, which specifies that no frame after the IDR frame can reference another frame occurring before the IDR frame. The rate controller then initializes (402) a target size for the current frame and retrieves (404) a size of the currently encoded frame.

The rate controller then can process the following decision logic. If the size of the currently encoded frame is less than the target size, as determined at 406, then the target size can be set to the initial target size for the zero-buffering mode. Otherwise, if the size of the currently encoded frame is less than a given threshold above the target size, as determined at 408, then the target size for the next image to be processed is adjusted. If the size of the currently encoded frame is greater than the given threshold above the target size, as determined at 410, then the target size for the current image is updated, and an attempt to re-encode the current image can be made if computational resources are available. If the size of a re-encoded current image is greater than the updated target size, then at least the current frame can be dropped. One or more additional future frames also can be dropped. After these tests, the rate controller addresses the next image processed by the video encoder and retrieves (404) the size of that next image.

Thus, as shown in FIG. 4, in response to a determination (at 406) that the currently encoded frame is less than the target size, the rate controller computes (412) the target size for the next frame as the initial target size of the zero-buffering mode. In response to a determination (408) that the currently encoded frame is within a threshold of the target size, the rate controller computes (414) the target size for the next frame as a function of the difference between the target size and actual size for the current frame. In response to the video encoder producing a re-encoded current frame within the target size or dropping the current frame, the rate controller computes (416) the target size of the next frame as the initial target size for the zero-buffering mode. After the rate controller computes (412, 414 or 416) the target size for the next frame, the rate controller can set the target size in the video encoder for use in encoding the next frame. Either computation at 412 or 414 can be used as a condition for initiate exiting the zero-buffering mode.

In response to the determination (410) that the actual size of the encoded current frame exceeds the target size by the specified threshold, the rate controller instructs (418) the video encoder to re-encode the current frame to match the target size. For example, the video encoder can be instructed to use a different set of quantization parameters or other encoding parameters to achieve more data compression. The rate controller then receives the actual size of the re-encoded current frame. If the re-encoded current frame is greater than the target size, as determined at 422, then the current frame can be dropped (in which case the video encoder is instructed to drop the frame, thus indicating it as dropped and skipped in the encoded bitstream); otherwise the re-encoded current frame is retained in the encoded bitstream. Thus, in response to a determination that the re-encoded current frame is greater than the target size, the rate controller can instruct the video encoder to drop the current frame. In response to a determination that the re-encoded current frame is within the target size, the rate controller instructs the video encoder to retain the re-encoded current frame. In response to the video encoder producing a re-encoded current frame within the target size or dropping the current frame, the rate controller computes (416) the target size of the next frame as the initial target size for the zero-buffering mode.

In an example implementation, if the re-encoded current frame is greater than the target size, instead of dropping the frame, the rate controller can instruct the video encoder to scale the current image to a smaller spatial resolution, and re-encode the scaled image. For example, the image can be scaled by a fifty percent on each dimension. In this implementation resolution change information can be included in the encoded bitstream for transmission to any video decoder or can be provided through another data channel to any video decoder. A scaled image can be encoded as an intraframe, as an IDR frame or as a predictive frame with a corresponding scaling of motion vectors.

In a particular example implementation, the rate controller can compute the initial target size (Sc) in bits as a function of a duration (D) in seconds of a frame and value, such as either a target bit rate or an available bandwidth (B), or function of both, in bits per second. For example, Sc=D×B. Such a computation would provide an optimum average value for the initial target size Sc; thus, the function defining this initial target size Sc can be specified to result in a range centered on this value. The target size T for a current frame can be initially set to this initial target size (T=Sc). The rate controller can set the threshold (A) in bits by which a current encoded frame size (C) can exceed the target size (T) for that frame. In one example, a useful value for A is about 10%, or in a range of 5% to 20%. The rate controller can compute a comparison by computing C<T(1+A). A number N of frames over which the zero-buffering mode can operate can be set of a small number of frames, such as 3 or more and less than about 10, such as about 5.

In one implementation, the normal mode of operation of the rate controller can include a rate control process that sets a target size for a current frame based on a function of the duration (D) of a frame in units of time, and a bit rate or available bandwidth (B) along with a number of initially available buffers (L) and a measure (F) of buffer fullness, which L and F being in units of time. The target size for a current frame (T) in the unit of bits can be a function of the maximum available buffer space (Smax), which can be computed by Smax=L+(D)×B−F. Notably, when L=0 and F=0, a zero buffer case, Smax=Sc. In some implementations, the duration D of a frame and the available bandwidth or bit rate B may be changing over time, or can be dependent on the connection between the host computer and the remote client computer. Thus values D and B can be dynamically determined at the time of transmission of encoded bitstreams, and can represent estimated or measured values. In other implementations, given a rate controller using a specification of a target size for a compressed frame as a function of initially available buffers and currently used buffers, such a specification can be converted to a zero-buffering mode of operation by setting these values to zero. In turn, an initial target size, when initiating compressing of images after a scene change, can be determined for a zero-buffering mode.

In the foregoing example implementations, an indication of detection of a scene change (e.g., 214 in FIG. 2) is provided to the rate controller (e.g., 204 in FIG. 2). A scene change can be identified in the screen content (e.g., 122 in FIG. 1) in a number of ways. In one example implementation, types of input 126 can be known to initiate a scene change. In another example implementation, when display data from multiple applications is being combined to generate the screen content, any application forming such a combination can indicate that a scene change is occurring in the screen content. In another example implementation, a comparison of a current frame to a next frame can be performed to detect a scene change. The invention is not limited to a particular implementation of how a scene change is detected in the screen content.

Having now described an example implementation, FIG. 5 illustrates an example of a computer in which such techniques can be implemented, whether implementing the host computer or remote client computer. This is only one example of a computer and is not intended to suggest any limitation as to the scope of use or functionality of such a computer.

The computer can be any of a variety of general purpose or special purpose computing hardware configurations. Some examples of types of computers that can be used include, but are not limited to, personal computers, game consoles, set top boxes, hand-held or laptop devices (for example, media players, notebook computers, tablet computers, cellular phones, personal data assistants, voice recorders), server computers, multiprocessor systems, microprocessor-based systems, programmable consumer electronics, networked personal computers, minicomputers, mainframe computers, and distributed computing environments that include any of the above types of computers or devices, and the like.

With reference to FIG. 5, an example computer 500 includes at least one processing unit 502 and memory 504. The computer can have multiple processing units 502. A processing unit 502 can include one or more processing cores (not shown) that operate independently of each other. Additional co-processing units, such as graphics processing unit 520, also can be present in the computer. The memory 504 may be volatile (such as dynamic random access memory (DRAM) or other random access memory device), non-volatile (such as a read-only memory, flash memory, and the like) or some combination of the two. The memory also can include registers or other storage dedicated to a processing unit or co-processing unit 520. This configuration of memory is illustrated in FIG. 5 by line 506. The computer 500 may include additional storage (removable and/or non-removable) including, but not limited to, magnetically-recorded or optically-recorded disks or tape. Such additional storage is illustrated in FIG. 5 by removable storage 508 and non-removable storage 510. The various components in FIG. 5 are generally interconnected by an interconnection mechanism, such as one or more buses 530.

A computer storage medium is any medium in which data can be stored in and retrieved from addressable physical storage locations by the computer. Computer storage media includes volatile and nonvolatile memory, and removable and non-removable storage media. Memory 504 and 506, removable storage 508 and non-removable storage 510 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. The computer storage media can include combinations of multiple storage devices, such as a storage array, which can be managed by an operating system or file system to appear to the computer as one or more volumes of storage. Computer storage media and communication media are mutually exclusive categories of media.

Computer 500 may also include communications connection(s) 512 that allow the computer to communicate with other devices over a communication medium. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, radio frequency, infrared and other wireless media. Communications connections 512 are devices, such as a wired network interface, wireless network interface, radio frequency transceiver, e.g., Wi-Fi, cellular, long term evolution (LTE) or Bluetooth, etc., transceivers, navigation transceivers, e.g., global positioning system (GPS) or Global Navigation Satellite System (GLONASS), etc., transceivers, that interface with the communication media to transmit data over and receive data from communication media, and may perform various functions with respect to that data.

Computer 500 may have various input device(s) 514 such as a keyboard, mouse, pen, stylus, camera, touch input device, sensor (e.g., accelerometer or gyroscope), and so on. The computer may have various output device(s) 516 such as a display, speakers, a printer, and so on. All of these devices are well known in the art and need not be discussed at length here. The input and output devices can be part of a housing that contains the various components of the computer in FIG. 5, or can be separable from that housing and connected to the computer through various connection interfaces, such as a serial bus, wireless communication connection and the like. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, hover, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye, and gaze tracking, immersive augmented reality and virtual reality systems, all of which provide a more natural interface, as well as technologies for sensing brain activity using electric field sensing electrodes (such as electroencephalogram techniques and related methods).

The various storage 510, communication connections 512, output devices 516 and input devices 514 can be integrated within a housing with the rest of the computer, or can be connected through input/output interface devices on the computer, in which case the reference numbers 510, 512, 514 and 516 can indicate either the interface for connection to a device or the device itself as the case may be.

A computer generally includes an operating system, which is a computer program that manages access to the various resources of the computer by applications. There may be multiple applications. The various resources include the memory, storage, communication devices, input devices and output devices, such as display devices and input devices as shown in FIG. 5.

The operating system and applications can be implemented using one or more processing units of one or more computers with one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct the processing unit to perform operations on data or configure the processor or computer to implement various components or data structures.

Accordingly, in one aspect, a host computer can include a video encoder and a rate controller configured to control the video encoder. The video encoder includes an input configured to receive a target size of compressed image data for a next image to be encoded. A first output is configured to output an encoded image according to the received target size. A second output is configured to output an actual size of the encoded image. The rate controller includes a first input configured to receive an indication of a scene change, a second input coupled to the second output of the video encoder and configured to receive the actual size of the encoded image. An output is configured to output a target size for the next image to be encoded. The rate controller is configured to have a first mode of operation and a second mode of operation, and to transition to the second mode of operation based at least on the indication of the scene change.

In another aspect, a host computer can include a video encoder and a rate controller configured to control the video encoder. The video encoder includes an input configured to receive a target size of compressed image data for a next image to be encoded. A first output is configured to output an encoded image according to the received target size. A second output is configured to output an actual size of the encoded image. The host computer includes a means, operative in response to a scene change, for controlling a rate of output of the video encoder.

In another aspect, a computer storage medium includes computer program instructions stored thereon which, when processed by a processing system of a computer, configure a computer to comprise a video encoder comprising an input configured to receive a target size of compressed image data for a next image to be encoded, a first output configured to output an encoded image according to the received target size, and a second output configured to output an actual size of the encoded image. The computer is further configured to comprise a rate controller comprising a first input configured to receive an indication of a scene change, a second input coupled to the second output of the video encoder and configured to receive the actual size of the encoded image, and an output configured to output a target size for the next image to be encoded. The rate controller is further configured to have a first mode of operation and a second mode of operation, and to transition to the second mode of operation based at least on the indication of the scene change.

In another aspect, a process comprises encoding, by a video encoder, image data using a first mode of operation of a rate controller for the video encoder. The process comprises, based on at least an input indicating a detection of a scene change in the image data, transitioning from the first mode of operation to a second mode of operation of the rate controller for the video encoder. This process also comprises encoding a first image after the scene change using intraframe encoding.

In another aspect, a computer comprises means for encoding image data using a first mode of operation of a rate controller for the video encoder. The computer comprises means, based on at least an input indicating a detection of a scene change in the image data, for transitioning from the first mode of operation to a second mode of operation of the rate controller for the video encoder. This computer also comprises means for encoding a first image after the scene change using intraframe encoding.

In any of the foregoing aspects, rate control after a scene change comprises a zero-buffering mode.

In any of the foregoing aspects, rate control after a scene change comprises minimizing latency in generating and transmitting the encoded bitstream of each image for a number of images after the scene change.

In any of the foregoing aspects, rate control after a scene change comprises setting a target size of an image to an amount of data that can be transmitted to the remote client computer in one period of a temporal sampling rate of the screen content as displayed at the remote client computer.

In any of the foregoing aspects, rate control after a scene change comprises setting a target size of an encoded image based on a function of the duration of display of one frame of screen content and a target bit rate for transmission of one frame.

In any of the foregoing aspects, a first mode of rate control and rate control after a scene change comprises setting a target size of an encoded image based on a function of a duration of a frame in units of time, a bit rate or available bandwidth, a number of initially available buffers and a measure of buffer fullness, wherein the number of initially available buffers and the measure of buffer fullness are non-zero in the first mode and are zero after the scene change.

In any of the foregoing aspects, the rate controller, in the zero-buffering mode, can be further configured to instruct the video encoder to encode at least a first image after the scene change as an intraframe encoded image.

In any of the foregoing aspects, the rate controller, in the zero-buffering mode, can be further configured to compute a target size for encoded image data, generated by the video encoder for an image, based on no buffers for additional images being available to store encoded image data. The target size can be based on no additional delay being allowed from picture buffering.

In any of the foregoing aspects, the rate controller, in the zero-buffering mode, can be further configured to compare an actual size of encoded image data for an image to a threshold based on a target size. The rate controller can be configured to, in response to the actual size exceeding the threshold, instruct the video encoder to re-encode the image.

In any of the foregoing aspects, the rate controller, in the zero-buffering mode, can be further configured to compare an actual size of a re-encoded image data for an image to a threshold based on a target size. The rate controller can be configured to, in response to the actual size of the re-encoded exceeding the threshold, instructing the video encoder to indicate the image is dropped from the encoded bitstream.

In any of the foregoing aspects, the rate controller, in the zero-buffering mode, can be further configured to compare an actual size of encoded image data for a current image to a threshold based on a target size for the current image. The rate controller can be configured to, in response to the actual size of the current image exceeding the threshold, compute a target size for encoded image data for the next image based on the actual size of the current image.

In any of the foregoing aspects, the rate controller can be configured to operate in the zero-buffering mode for processing of a number of images and then transition to the first mode.

In any of the foregoing aspects, the image data can include images of screen content of the computer. The computer can be configured to transmit the encoded image data to a remote client computer.

In any of the foregoing aspects, the rate controller can be further configured to compute an initial target size after detection of the scene change as a function of a duration of a single frame and a value in bits per second.

In any of the foregoing aspects, the host computer can be connected to a remote client computer that receives the encoded image data output by the video encoder.

In any of the foregoing aspects, the image encoded by the video encoder comprises screen content generated by an application executed on the host computer.

In any of the foregoing aspects, the screen content comprises image data of an interactive video session.

In any of the foregoing aspects, the screen content comprises image data of a remote desktop application.

In any of the foregoing aspects, the remote client computer can be a mobile device, a tablet computer, a display device, or other kind of computer.

Any of the foregoing aspects may be embodied in one or more computers, as any individual component of such a computer, as a process performed by one or more computers or any individual component of such a computer, or as an article of manufacture including computer storage with computer program instructions are stored and which, when processed by one or more computers, configure the one or more computers.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A computer comprising:
a video encoder comprising an input configured to receive a target size of compressed image data for a next image to be encoded, a first output configured to output an encoded image according to the received target size, and a second output configured to output an actual size of the encoded image; and
a rate controller comprising a first input configured to receive an indication of a scene change, a second input coupled to the second output of the video encoder and configured to receive the actual size of the encoded image, and an output configured to output a target size for the next image to be encoded;
the rate controller configured to have a first mode of operation and a second mode of operation, and to transition to the second mode of operation based at least on the indication of the scene change.

2. The computer of claim 1, wherein the second mode of operation comprises a zero-buffering mode.

3. The computer of claim 2, wherein the rate controller, in the zero-buffering mode, is further configured to instruct the video encoder to encode at least a first image after the scene change as an intraframe encoded image.

4. The computer of claim 2, wherein the rate controller, in the zero-buffering mode, is further configured to compute a target size for encoded image data, generated by the video encoder for an image, based on no buffers for additional images being available to store encoded image data, and no additional delay allowed from picture buffering.

5. The computer of claim 2, wherein the rate controller, in the zero-buffering mode, is further configured to:
compare an actual size of encoded image data for an image to a threshold based on a target size; and
in response to the actual size exceeding the threshold, instruct the video encoder to re-encode the image.

6. The computer of claim 5, wherein the rate controller, in the zero-buffering mode, is further configured to:
compare an actual size of a re-encoded image data for an image to a threshold based on a target size; and
in response to the actual size of the re-encoded exceeding the threshold, instructing the video encoder to indicate the image is dropped from the encoded bitstream.

7. The computer of claim 2, wherein the rate controller, in the zero-buffering mode, is further configured to:
compare an actual size of encoded image data for a current image to a threshold based on a target size for the current image; and
in response to the actual size of the current image exceeding the threshold, compute a target size for encoded image data for the next image based on the actual size of the current image.

8. The computer of claim 2, wherein the rate controller is configured to operate in the zero-buffering mode for processing of a number of images and then transition to the first mode.

9. The computer of claim 1, wherein the image data comprises images of screen content of the computer, and wherein the computer is configured to transmit the encoded image data to a remote client computer.

10. The computer of claim 1, wherein the rate controller is further configured to compute an initial target size after detection of the scene change as a function of a duration of a single frame and a value in bits per second.

11. An article of manufacture comprising:
a computer storage medium, and computer program instructions stored on the computer storage medium which, when processed by a processing system of a computer, configure the computer to comprise:
a video encoder comprising an input configured to receive a target size of compressed image data for a next image to be encoded, a first output configured to output an encoded image according to the received target size, and a second output configured to output an actual size of the encoded image; and
a rate controller comprising a first input configured to receive an indication of a scene change, a second input coupled to the second output of the video encoder and configured to receive the actual size of the encoded image, and an output configured to output a target size for the next image to be encoded;
the rate controller configured to have a first mode of operation and a second mode of operation, and to transition to the second mode of operation based at least on the indication of the scene change.

12. The article of manufacture of claim 11, wherein the second mode of operation comprises a zero-buffering mode.

13. The article of manufacture of claim 12, wherein the rate controller, in the zero-buffering mode, is further configured to instruct the video encoder to encode a first image after the scene change as an interframe encoded image.

14. The article of manufacture of claim 12, wherein the rate controller, in the zero-buffering mode, is further configured to compute a target size for encoded image data, generated by the video encoder for an image, based on no buffers for additional images being available to store encoded image data, and no additional delay allowed from picture buffering.

15. The article of manufacture of claim 12, wherein the rate controller, in the zero-buffering mode, is further configured to:
compare an actual size of encoded image data for an image to a threshold based on a target size; and
in response to the actual size exceeding the threshold, instruct the video encoder to re-encode the image.

16. A computer-implemented process, comprising:
encoding, by a video encoder, image data using a first mode of operation of a rate controller for the video encoder;
based on at least an input indicating a detection of a scene change in the image data, transitioning from the first mode of operation to a second mode of operation of the rate controller for the video encoder; and
encoding a first image after the scene change using intraframe encoding.

17. The computer-implemented process of claim 16, wherein the second mode of operation comprises a zero-buffering mode.

18. The computer-implemented process of claim 17, wherein while in the zero-buffering mode instructing, by the rate controller, the video encoder to encode a first image after the scene change as an interframe encoded image.

19. The computer-implemented process of claim 17, wherein while in the zero-buffering mode, computing, by the rate controller, a target size for encoded image data, generated by the video encoder for an image, based on no buffers for additional images being available to store encoded image data.

20. The computer-implemented process of claim 17, wherein while in the zero-buffering mode:
comparing, by the rate controller, an actual size of encoded image data for an image to a threshold based on a target size; and
in response to the actual size exceeding the threshold, instructing, by the rate controller, the video encoder to re-encode the image.
